(19) United States
(12) Patent Application Publication
(10) Pub. No.: US 2009/0275409 A1
(43) Pub. Date: Nov. 5, 2009

(54) GAME MACHINE, GAME SYSTEM, AND COMPUTER-READABLE STORAGE MEDIUM

(75) Inventors: Tetsuro Itami, Tokyo (JP); Yukie Yamazaki, Tokyo (JP)

Correspondence Address: DARBY & DARBY P.C., P.O. BOX 770, Church Street Station, New York, NY, 10008-0770, US

(73) Assignee: KONAMI DIGITAL ENTERTAINMENT CO., LTD., Tokyo (JP)

(21) Appl. No.: 12/096,065

(22) PCT Filed: Nov. 24, 2006
(86) PCT No.: PCT/JP2006/323439

§ 371 Date: Jun. 4, 2008

(30) Foreign Application Priority Data
Dec. 9, 2005 (JP) 2005-357024

(51) Int. Cl. A63F 13/00; A63F 9/24

(52) U.S. Cl. 463/35; 463/43

(57) ABSTRACT

A game machine of playing a game is provided in which music unique to a character is generated as the character advances its morphologic changes. The game machine of the present invention obtains a morphology changing factor and changes a morphologic change status of a character. When the morphologic change status of the character satisfies any of the evolution requirements provided to the next evolution stage of the current character, the game machine sets the evolution morphology correlated to the evolution requirement as a character morphology. It also generates an evolution melody on the basis of the character melody for the character and a morphology melody which is a melody unique to the evolution morphology of the character, and sets the evolution melody generated as an advanced character melody.

### TECHNICAL FIELD

The present invention relates to a game machine of playing a game in which a character changes its morphology, a game system, and a computer-readable storage medium.

### RELATED ART

Games are widely known now, in which a character changes its morphology when a morphology changing factor is provided (For example, Patent document 1 and Patent document 2). A game is also known in which images are displayed on a screen according to sound inputs (For example, Patent document 3).

[Patent document 1] JP 9-A-237328

[Patent document 2] JP 10-A-207342

[Patent document 3] JP 2001-A-29649

### SUMMARY OF INVENTION

### Problems to be Solved by the Invention

In the conventional game, however: only a character is displayed on a display screen, which is selected according to the information inputted.

It is an object of the present invention to provide a game machine of playing a game in which music unique to a character is generated according to the evolution process of the character which changes its morphology.

### Means of Solving Problems

In order to address the above object, the game machine of the present invention is a game machine of playing a game in which a character evolves stepwise in a plurality of evolution processes with changing its morphology when a morphology changing factor is provided, the game machine includes: a character information storage device which stores character information, in which a character morphology indicating a current morphology of the character, a character melody which is a melody for the character morphology, and a morphologic change status of the character are correlated to each other; an evolution morphology information storage device which stores evolution morphology information, in which a plurality of evolution morphologies associated with the plurality of evolution processes, morphology melodies each of which is a melody unique to each of the plurality of evolution morphologies, and the respective evolution requirements for evolving to the plurality of evolution morphologies are correlated to each other; a morphology changing factor obtaining device which obtains a morphology changing factor; a character changing device which changes the morphologic change status of the character stored in the character information storage device according to the morphology changing factor obtained; and an evolution processing device which performs a process related to an evolution of the character when the morphologic change status of the character satisfies any of the evolution requirements in the evolution morphology information provided to the next evolution process of the current character, wherein the evolution processing device includes a morphology setting device which sets the evolution morphology correlated to the evolution requirement as the character morphology; and an evolution melody setting device which generates an evolution melody on the basis of the character melody for the character and the morphology melody correlated to the set evolution morphology, and which sets the evolution melody generated as an advanced character melody.

According to the game machine of the present invention, when a morphology changing factor is obtained by the morphology changing factor obtaining device, the morphologic change status of the character is changed by the character changing device. When the morphologic change status satisfies any of a plurality of the preset evolution requirements, the evolution morphology corresponding to the satisfied evolution requirement is set by the morphology setting device as a morphology of the character; and an evolution melody is generated by the evolution melody setting device on the basis of the character melody prior to evolution and the morphology melody for the evolution morphology.

A plurality of evolution morphologies are provided to each evolution process. A morphology melody is a melody unique to each of the evolution morphologies. Thus, even if a character has a same morphology, the evolution melody generated differs in accordance with the way the character evolves via evolution morphologies in the respective evolution processes. Thus, music unique to the character is generated as the character advances its morphologic changes.

The embodiments of generating an evolution melody on the basis of a character melody and a morphology melody includes a case in which the evolution melody is generated only from a character melody and a morphology melody, and a case in which the evolution melody is generated by adding other melody to these two melodies. Furthermore, the embodiments of generating an evolution melody includes a case in which a medley is generated by simply concatenating each of the melodies and a case in which a medley is generated by dividing each of the melodies to pieces and concatenating them together. The morphology changing factor may be the one obtained from the outside of the game machine or the one generated in the game machine. Furthermore, providing a morphology changing factor to a character means affecting the morphology changing factor in a manner that the character evolves. For example, it is considerable a case in which a character is provided with a virtual food or a case in which the machine makes a character to play a virtual sport.

The evolution melody may be generated by concatenating the morphology melody to the character melody. Accordingly, a character melody is generated as a medley of the morphology melodies. Thus, once a melody having a featuring character in its morphology melody, a character melody can be generated without losing the featuring character.

The morphology changing factor may be music data relating to playback music. The character changing device may include a genre determining device which determines a genre of the playback music from the music data obtained by the morphology changing factor obtaining device. The morphologic change status may be information relating to playback time periods during which music of the respective genres are play-backed. The evolution requirement may be a requirement based on the playback time period of the music of each of the genres.

Accordingly, for example, each of the evolution morphologies is set so as to correspond to each of the genres of music; and the evolution requirement is set such that when music of a specific genre is play backed for over a specific time period, the character evolves to the evolution morphology corresponding to the genre. Thus the style of the play backed music can be reflected to the morphology of the character. The embodiment of obtaining music data includes a case of obtaining music data of the music play-backed by an external play back device of the game machine and a case of obtaining music data of the music play-backed by an internal play back device provided in the game machine. The music data may be data of the playback music itself or data indicating the genre of the playback music.

The game machine may have an information storage device for a voice character which stores information for voice character, which is provided according to a level relating to a pitch of a voice, and in which each of a plurality of voice characters having different morphologies from each other and the unique voice character melody to the voice character are correlated; a voice input device which inputs voice data from outside; a voice character selecting device which selects, from the information for voice character, a voice character according to the voice data inputted by the voice input device; and a synthetic melody generating device which generates a synthetic melody by combining the voice character melody for the selected voice character and the character melody.

Accordingly, a voice character corresponding to a pitch level of the voice inputted from outside is selected by the voice character selecting device. Then, a synthetic melody is generated by the synthetic melody generating device by combining a voice character melody unique to the voice character and the character melody. Thus, even if a voice which can not be classified into genres is inputted, the voice is classified into levels according to the high and low of its frequency, a voice character can be set on the basis of the voice inputted from outside. Thus, games using various voices can be played. The voices include human and animal voices. The synthetic melody may be generated by inserting the voice character melody into the character melody, for example and vice versa.

In order to address the above object, the game system of the present invention is a game system of playing a game in which a character evolves stepwise in a plurality of evolution processes with changing its morphology when a morphology changing factor is provided, the game machine includes: a character information storage device which stores character information, in which a character morphology indicating a current morphology of the character, a character melody which is a melody for the character morphology, and a morphologic change status of the character are correlated to each other; an evolution morphology information storage device which stores evolution morphology information, in which a plurality of evolution morphologies associated with the plurality of evolution processes, morphology melodies each of which is a melody unique to each of the plurality of evolution morphologies, and the respective evolution requirements for evolving to the plurality of evolution morphologies are correlated to each other; a morphology changing factor obtaining device which obtains a morphology changing factor; a character changing device which changes the morphologic change status of the character stored in the character information storage device according to the morphology changing factor obtained; and an evolution processing device which performs a process related to the evolution of the character when the morphologic change status of the character satisfies any of the evolution requirements in the evolution morphology information provided to the next evolution process of the current character, wherein the evolution processing device includes a morphology setting device which sets the evolution morphology correlated to the evolution requirement as the character morphology; and an evolution melody setting device which generates an evolution melody on the basis of the character melody for the character and the morphology melody correlated to the set evolution morphology, and which sets the evolution melody generated as an advanced character melody.

The meanings of the devices which the game system of the present invention has and the meanings of the terms are same as those in the case of the game machine of the present invention. However, the devices are not required to be accommodated in a single game machine. The system may be constructed such that some device is connected to others via a communication line, for example.

In order to address the above object, the computer-readable storage medium of the present invention is a computer-readable storage medium of storing a computer program which makes a computer of a game machine of playing a game to function, in the game a character evolves stepwise in a plurality of evolution processes with changing its morphology when a morphology changing factor is provided, the game machine comprises a character information storage device which stores character information, in which a character morphology indicating a current morphology of the character, a character melody which is a melody for the character morphology, and a morphologic change status of the character are correlated to each other; and an evolution morphology information storage device which stores evolution morphology information, in which a plurality of evolution morphologies associated with the plurality of evolution processes, morphology melodies each of which is a melody unique to each of the plurality of evolution morphologies, and the respective evolution requirements for evolving to the plurality of evolution morphologies are correlated to each other, wherein the computer program makes the computer to function as: a morphology changing factor obtaining device which obtains a morphology changing factor; a character changing device which changes the morphologic change status of the character stored in the character information storage device according to the morphology changing factor obtained; and an evolution processing device which performs a process related to an evolution of the character when the morphologic change status of the character satisfies any of the evolution requirements in the evolution morphology information provided to the next evolution process of the current character, and wherein the evolution processing device is configured to function as: a morphology setting device which sets the evolution morphology correlated to the evolution requirement as the character morphology; and an evolution melody setting device which generates an evolution melody on the basis of the character melody for the character and the morphology melody correlated to the set evolution morphology, and which sets the evolution melody generated as an advanced character melody. With the computer program stored in the computer-readable storage medium, the game machine of the present invention can be embodied.

### EFFECT OF INVENTION

As described above, according to the present invention, a unique morphology melody is set for each of the evolution morphologies; and an evolution melody is set as music for the character by using the morphology melody corresponding to the advanced evolution morphology. Accordingly, even if a character has a same morphology, a different music is generated in accordance with its evolution history. Thus, a game machine and the like of playing a game can be provided in which music unique to a character is generated as the character advances its morphologic changes.

### BRIEF DESCRIPTION OF DRAWINGS

FIG. 1 is a front view of a game machine of the present invention.

FIG. 2 is a schematic view of the hardware structure of a game machine of FIG. 1.

FIG. 3 is a view illustrating an example of character information.

FIG. 4 is a schematic view showing source data constituting a morphologic change status.

FIG. 5 is a view illustrating an example of evolution morphology information.

FIG. 6 is a view showing the way how genres of the listened music are set as the source data constituting a morphologic change status.

FIG. 7 is a view showing the way a character evolves.

FIG. 8 is a flowchart showing a flow of the process in a morphologic change control process.

FIG. 9A is a view illustrating an example of information for a voice character.

FIG. 9B is a view illustrating an example of voice character information.

FIG. 10 is a flowchart showing a flow of the process in a voice character setting process.

FIG. 11 is a schematic view showing the way how a session melody is generated by a character and a voice character

FIG. 12 is a flowchart showing a flow of the process in a session process.

### BEST MODE FOR CARRYING OUT THE INVENTION

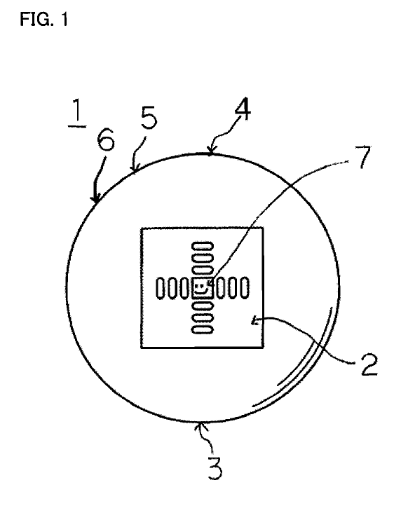

FIG. 1 is a view showing an appearance of a game machine 1 of the present invention. The front face of the game machine 1 has a substantially circular shape, and is provided with a rectangular screen 2 at its center. Along its outer periphery, the front face is provided with a sound input part 3, a sound output part 4, a selection button 5, and a cancel button 6, respectively. The screen 2 displays a menu, from which a character 7 or various process modes can be selected, for example. These will be described below. A microphone or a play back device for playing back music is connected to the sound input part 3, so as to input sound from outside. The play back device may be a device able to play back music, such as a MD player, a CD player, or a MP3 player, for example. Furthermore, the play back device may a component which outputs music in a home audio system, a television, or a commercial portable game machine.

The sound output part 4 is a part for outputting music play-backed by a playback device or melodies for various characters. A headset is connected to the sound output part, for example. A selection can be done with the selection button from the menu displayed on the screen 2, whereas the selection can be cancelled with the cancel button 6. It is noted that the shape of the game machine 1 and the shape of the screen 2 are not limited to the shapes in the present embodiment.

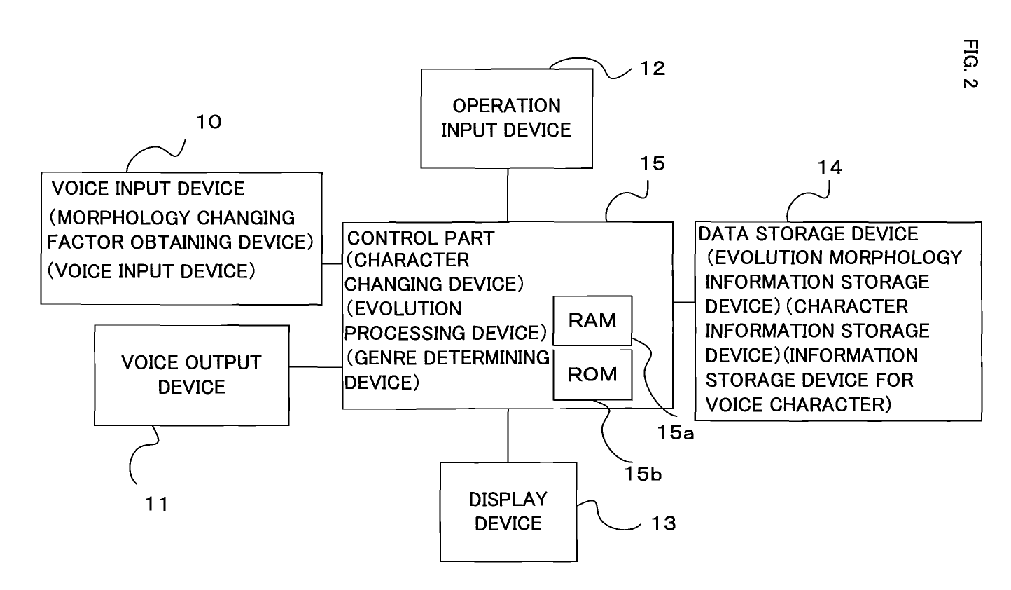

The hardware structure of the game machine 1 will be described with reference to FIG. 2. The hardware structure of the game machine 1 is constructed from a sound input device 10 including a sound input part 3, a sound output device 11 including a sound output part 4, an operation input device 12 including a selection button 5 and a cancel button 6, a display device 13 including a screen 2, a data storage device 14, and a control part 15. When a microphone is connected to the sound input part 3, the sound input device 10 inputs voice from the microphone and outputs it to the control part 15 as a voice input device. When a playback device is connected to the sound input part 3, the sound input device 10 inputs playback music and outputs it to the control part 15 as a morphology changing factor obtaining device, wherein the playback music serves as a morphology changing factor. The sound output device 11 outputs sound from its internal speaker which is outputted from the control part 15 or the sound input device 10. The sound output device 11 outputs sound to the sound output part 4 when a headset is connected to the sound output part 4.

The operation input device 12 receives operation of a user and outputs operation data corresponding to their operation to the control part 15. The display output device 13 displays image data outputted from the control part 15 on the screen 2. The control device 15 is constructed as a computer including a CPU and its peripheral circuits necessary for its operation, such as a RAM 15a and a ROM 15b. The control device 15 controls the components 10-14 and functions mainly as a character changing device, an evolution processing device, and a genre determining device. ROM 15b stores a computer program for embodying the present invention.

In the following, a procedure of changing the morphology of a character 7 will be described with mentioning to the function of above-mentioned components 10-15. When data of the playback music is obtained by the morphology changing factor obtaining device of the sound input device 10, a genre for the inputted music is determined by the genre determining device 15; and morphologic change status is updated corresponding to the genre determined by the character changing device 15. Then, a process for evolving the character 7 is performed by the evolution processing device 15 when the morphologic change status satisfies evolution requirements. It is noted that the operation input device 12 of the game machine 1 includes a power switch and that the above-mentioned devices operate when the machine is powered on with the power switch.

According to the game machine 1 of the present invention, a user is able to display a character 7 having a morphology fitting to a style of music on the screen 2 and generate a unique melody for their character while listening to music play-backed by the playback device. In the present embodiment, the character 7 is at its initial stage when a game is started, and later it evolves stepwise to four evolution stages. In the following, the processes performed in the game machine 1 will be described specifically.

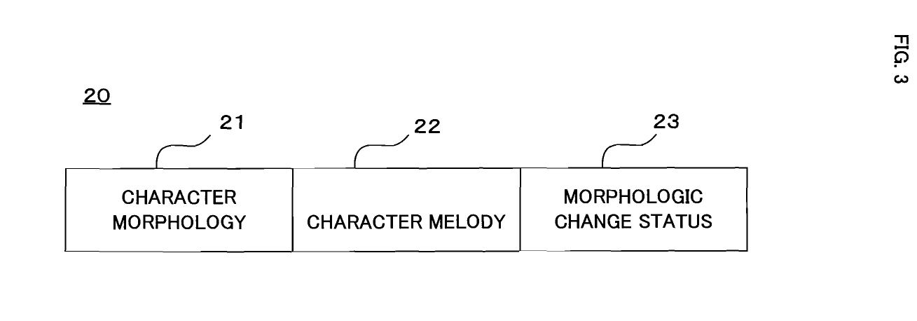

Data stored in the data storage device 14 will be described. First, the data storage device 14 stores character information 20 as a character information storage device. The information is information on the current character 7 as shown in FIG. 3. The character information 20 includes information on a character morphology 21, a character melody 22, and a morphologic change status 23. The character morphology 21 indicates a current morphology of a character 7. The character melody 22 is data indicating a melody unique to a character 7 which is generated as the character 7 evolves. In the following, the melody indicated by the character melody 22 is sometimes referred as “a melody for a character 7”.

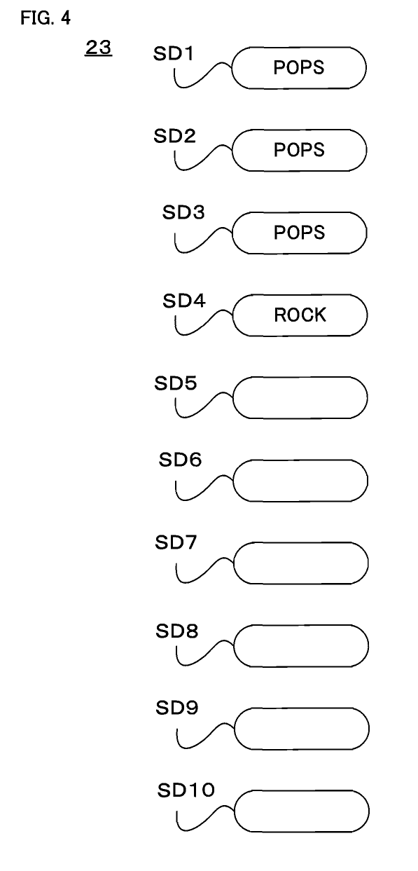

The morphologic change status 23 is data indicating a current morphologic change status of a character 7. The morphologic change status 23 is made up of a plurality of source data SD1-SD10 as shown in FIG. 4. When it is not necessary to explicitly distinguish the source data SD1-SD10 in the following, it will be referred as a source data SD. When music is play-backed by a user through a playback device, a genre of the music is determined by using the method described below. The determined genre is set in the source data SD. As the character advances its evolution stage, the number of source data SD in the morphologic change status 23 increases by two, for example, like 10 at the initial stage, 12 at the first stage, 14 at the second stage, and so on. The example shown in FIG. 4 is an example of the morphologic change status 23 at the initial stage, and shows a situation in which the source data SD1-SD3 are set as “Pops”, the source data SD4 is set as “Rock”, whereas the source data SD5-SD10 have not yet been set.

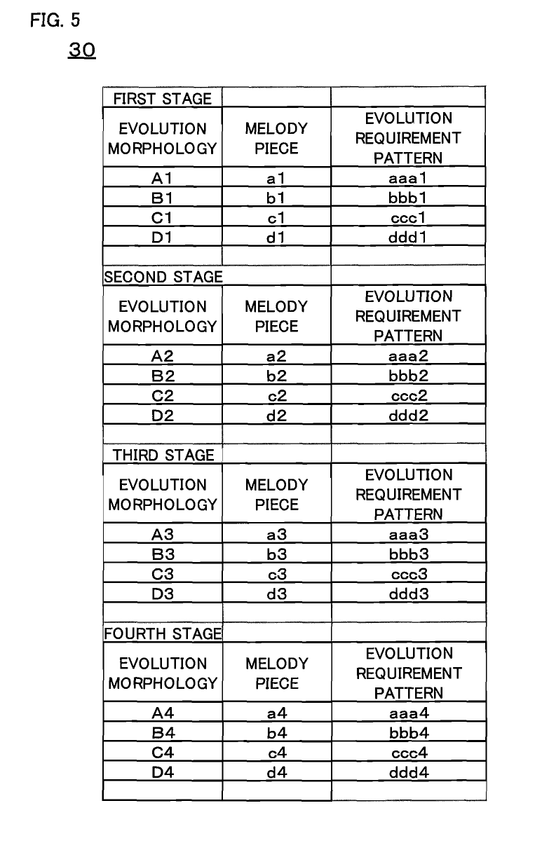

Furthermore, the data storage device 14 stores evolution morphology information as an evolution morphology information storage device. The evolution morphology information 30 will be described with reference to FIG. 5. As the evolution morphology information 30, four evolution morphologies are provided to each evolution stage; and a melody piece and an evolution requirement pattern are correlated to each of the evolution morphologies. The melody piece serves as a unique morphology melody to the evolution morphology; and the evolution requirement pattern serves as an evolution requirement. For example, in the case of the first stage, the evolution requirement pattern aaa1 is an evolution requirement required for the character 7 at its initial stage to have the evolution morphology A1; and the melody piece a1 is correlated to the evolution morphology A1. Furthermore, in the case of the second stage, the evolution requirement pattern bbb2 is an evolution requirement required for the character 7 at its first stage to obtain the evolution morphology B2; and the melody piece b2 is correlated to the evolution morphology B2. It is noted that the melody piece may be as short as one-phrase long.

Four types of evolution morphologies are set individually for respective styles of music. In the present embodiment, the evolution morphologies A1, A2, A3, A4 are set as Pop style; the evolution morphologies B1, B2, B3, B4 are set as Rock style; the evolution morphologies C1, C2, C3, C4 are set as Dance style; and the evolution morphologies D1, D2, D3, D4 are set as Elegant style. In the following, when it is not necessary to specifically distinguish the evolution stages, these will be referred as Pop style evolution morphology A, Rock style evolution morphology B, Dance style evolution morphology C, and Elegant style evolution morphology D. Each evolution morphology A, B, C, D is preferably a morphology which gives an image of music corresponding to its style of music. For example, the Rock style evolution morphology B may be an angulated morphology, whereas the Elegant style evolution morphology D may be a morphology which gives an elegant impression.

The evolution requirement pattern for each of the evolution stages is a pattern of the genres set in the source data SD, and a pattern required for a character to evolve to the respective evolution morphologies A, B, C, and D at its evolution stage. When music of a specific genre is frequently listened, the pattern is set such that the character evolves to the evolution morphology fitted to the frequently listened genre. In the present embodiment, the evolution requirement pattern may be set on the basis of 19 types of genres, since 19 types of genres are distinguished. For example, the evolution requirement pattern aaa1 required for a character 7 to evolve from the initial stage to the Pop style evolution morphology A1 may be set as “More than five source data SD are set as Pops”; and the evolution requirement pattern ccc1 required for a character 7 to evolve to the Dance style evolution morphology C1 may be set as “More than six source data SD are set as R&B, Hip-Hop, or Dance”. Furthermore, the ratio of genres which is set in the source data SD may be set like “Folk:Rock=7:3”.

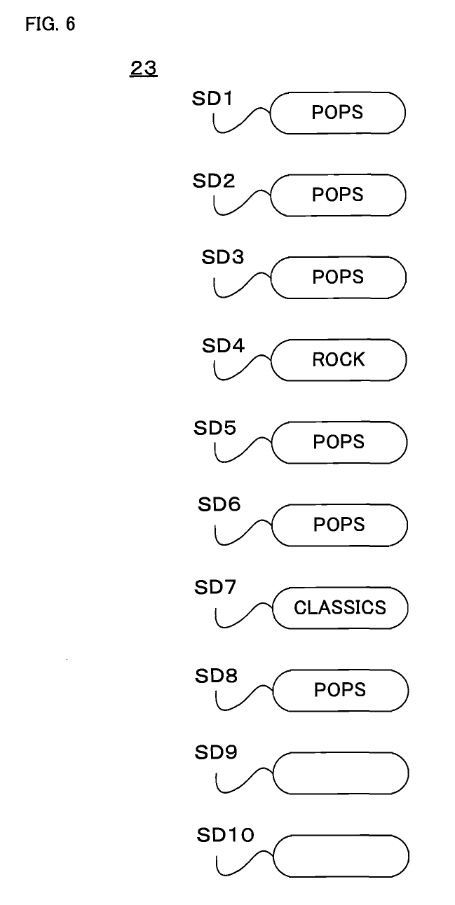

In a case that the above-mentioned evolution requirement pattern is set, when six source data SD are set as “Pops” in the morphologic change status 23 of the character 7 at its initial stage as shown in FIG. 6, for example, the character 7 at the initial stage evolves to the Pop style evolution morphology A1. In this case, the evolution melody “a1” is generated which is correlated to the evolution morphology A1. Furthermore, when the character 7 having the evolution morphology A1 at its first stage evolves to the evolution morphology C2 at its second stage, the evolution melody “a1+c2” is generated by concatenating the melody piece c2, which is correlated to the evolution morphology C2, to the character melody 22.

Thus, the evolution melody generated along with the evolution of the character 7 is a medley of the melody pieces correlated to the passed evolution morphologies. In the following, the character 7 of the evolution morphology A1 is sometimes referred as the character A1, and the character 7 of the evolution morphology C2 is sometimes referred as the character C2. The same applies for other evolution morphologies. It is noted that the data storage device 14 functions further as an information storage device for a voice character which stores information of the voice character. It will be further described below.

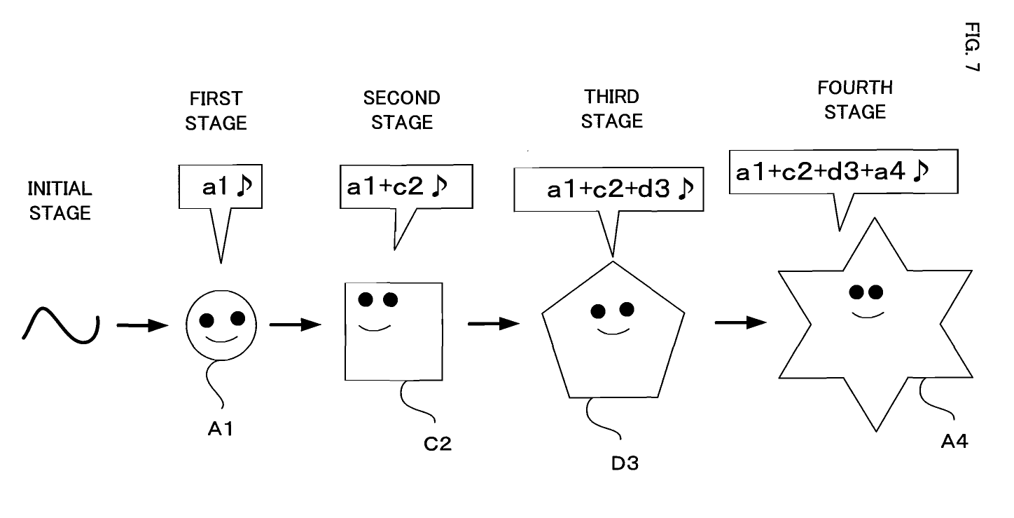

As described above, the character 7 evolves with changing its morphology in accordance with the evolution requirement at each of the evolution stages and setting the evolution melody brought by the evolution as its own melody. FIG. 7 illustrates a specific example in which a character 7 evolves from the initial stage to the fourth stage. The character 7 has a morphology of a simple curved line at its initial stage. When the evolution requirement pattern aaa1 is satisfied at the initial stage, its character morphology 21 is set as the evolution morphology A1; and its character melody 22 is set as a1 at the first stage, as described above. When the evolution requirement pattern ccc2 is satisfied at the first stage, the character morphology 21 will be the evolution morphology C2; and the character melody 22 will be a1+c2 by concatenating the melody piece c2 for the evolution morphology C2 to the character melody a1 of the first stage at the second stage.

Similarly at the third stage, when the evolution requirement pattern ddd3 is satisfied, the character morphology 21 will be the evolution morphology D3; and the character melody 22 will be a1+c2+d3. At the fourth stage, when the evolution requirement pattern aaa4 is satisfied, the character morphology 21 will be the evolution morphology A4; and the character melody 22 will be a1+c2+d3+a4. Since the melody for the character 7 is generated as a medley of the melody pieces correlated to the passed evolution morphology, even if the character 7 has finally a same evolution morphology A4 at its fourth stage, the melody generated will differ according to the evolution history. It is noted that the melody for the character 7 is play-backed when “Playback mode” is selected in the menu, for example.

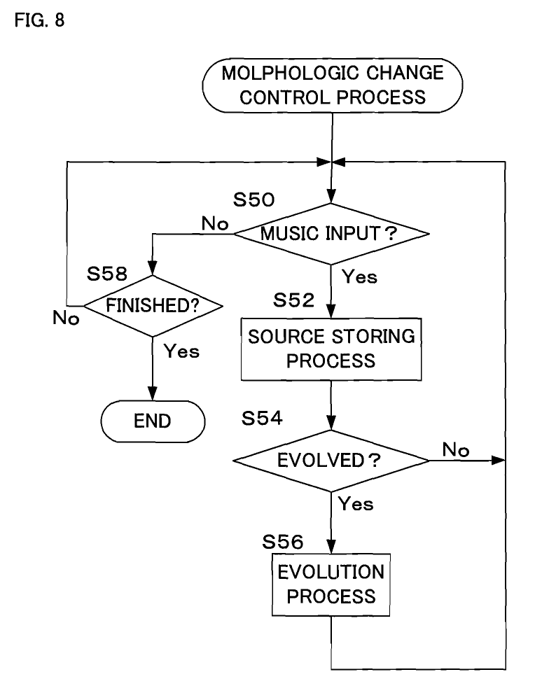

A morphologic change control process, which is performed in the game machine 1 so as to change the morphology of a character, will be described with reference to the flowchart shown in FIG. 8. The morphologic change control process is performed by the control part 15 of the game machine 1, when the game machine 1 is powered on, for example. First, music is inputted from the sound input part 3 into the sound input device 10 in step S50. When music is inputted, the process advances to step S52, and a source storing process is performed. In the source storing process, the inputted music is sampled so as to determine the genre of it, and the determined genre is set in the source data SD. Accordingly, the control part 15 functions as a genre determining device and a source storage device.

In the present embodiment, the genre of the inputted music is determined every 5 minutes. For example, the genre may be determined by presetting musical feature, such as tempo, base beat, and an average number of sounds for each of the genres in the data storage device 14, analyzing the musical feature of the inputted music, selecting a genre similar to the musical feature, and determining it as the genre of the inputted music. It is noted that 19 types of genres such as “Chill”, “Ballade”, “Healing”, and “R&B” are distinguished in the present embodiment as described above.

Next, the process advances to step S54, it is determined whether the character 7 evolves. The source data SD of the morphologic change status 23 and the evolution requirement pattern for the next evolution stage are compared. When the pattern of the source data SD satisfies any of the evolution requirement patterns, the character 7 evolves to the evolution morphology corresponding to the evolution requirement pattern. When it is determined that it evolves to any of the evolution morphologies, the process advances to step S56 and an evolution process is performed. When it is determined that it does not evolve, the process returns to step S50. In the evolution process, the character morphology 21 of the character information 20 is set as the evolution morphology which satisfies the evolution requirement. Furthermore, an evolution melody is generated by concatenating the melody piece correlated to the evolution morphology to the character melody 22 prior to evolution; and the evolution melody generated is set as the character melody 22 after evolution. Accordingly, the control part 15 functions as a morphology setting device of the evolution processing device and as an evolution melody setting device. Furthermore, two source data SD are added in the morphologic change status 23, and the settings in the source data SD are cleared.

On the other hand, when no music is inputted in step S50, the process advances to step S58, and it is determined whether to finish the morphologic change control process. For example, when no music is inputted for over a specified time period, it is determined that the process is to be finished; and the morphologic change control process is finished. When it is determined that the process is not to be finished, the process returns to step S50.

Apart from the character 7, a voice character can be set in the game machine 1 according to a voice, which is a human voice inputted from a microphone connected to the sound input part 3, for example. The voice character is set according to a pitch level of the inputted voice. Accordingly, when multiple types of voices are inputted, voice characters are set according to the pitch level of the respective voice. The information relating to a configurable voice character is stored in the information 70 for a voice character. The information 70 for a voice character is stored in the data storage device 14. Accordingly, the data storage device 14 functions as an information storage device for a voice character.

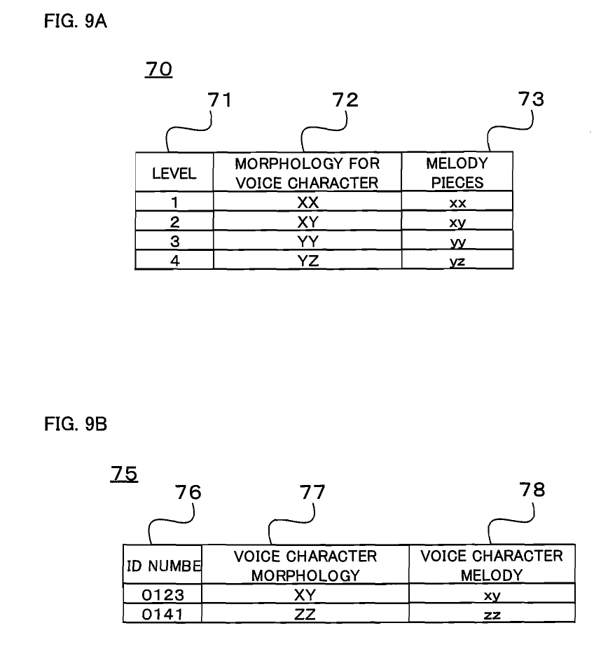

The information 70 for a voice character includes a level 71, a morphology 72 for the voice character, and a melody piece 73 as shown in FIG. 9A. The level 71 is information indicating the pitch level of a voice. In the present embodiment, five levels are provided. The morphology 72 for a voice character is information indicating a morphology of each voice character. The melody piece 73 is information indicating a melody unique to each morphology. On the other hand, the information relating to the set voice character is also stored in the data storage device 14 as voice character information 75 shown in FIG. 9B. The voice character information 75 includes an identification number 76, a voice character morphology 77, and a voice character melody 78. The identification number 76 is a number for identifying each of a plurality of set voice characters. The voice character morphology 77 is information indicating the morphology of the set voice character. The voice character melody 78 is information indicating data of the melody for the set voice character.

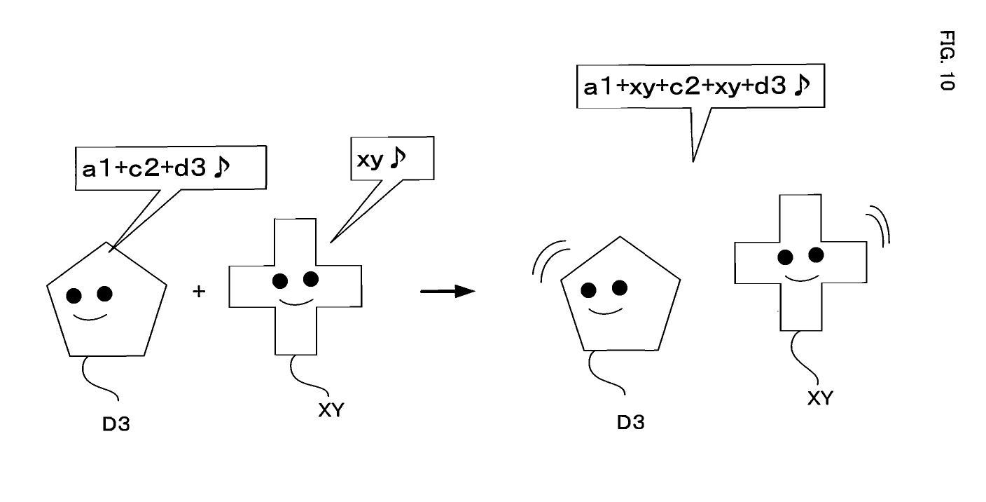

A voice character setting process will be described with reference to the flowchart in FIG. 10. A voice character is set corresponding to the inputted voice in the voice character setting process. The voice character setting process starts when “MIC mode” is selected in the menu; and the process is performed by the control part 15. First, the pitch level of the inputted voice is determined in step S80. When the pitch level of the inputted voice is determined, the process advances to step S82; and a morphology 72 for the voice character corresponding to the determined level is selected and set as the voice character morphology 77. Accordingly, the control part 15 functions as a voice character selecting device. Furthermore, the process advances to step S84; and the melody piece 73 corresponding to the determined level is set as the voice character melody 78. It is noted that as for the method of determining the pitch level of a voice, the pitch level of a voice may be determined to any of the five levels by analyzing the frequency of the inputted voice.

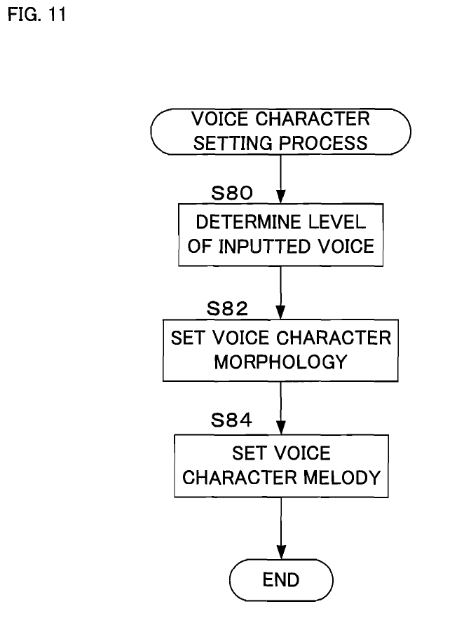

In the “Playback mode” of the menu, a session melody may be generated and play-backed, which is a combination of the melody for the character 7 and the melody for the voice character. For example, when the melody for the character D3 is “a1+c2+d3” and the melody for the voice character XY is xy as shown in FIG. 11, the session melody generated in the present embodiment will be “a1+xy+c2+xy+d3” by incorporating the melody xy to each of the melody pieces in the melody for the character D3. When the session melody is play-backed, an image in which the character D3 and the voice character XY are dancing together is displayed on the screen 2.

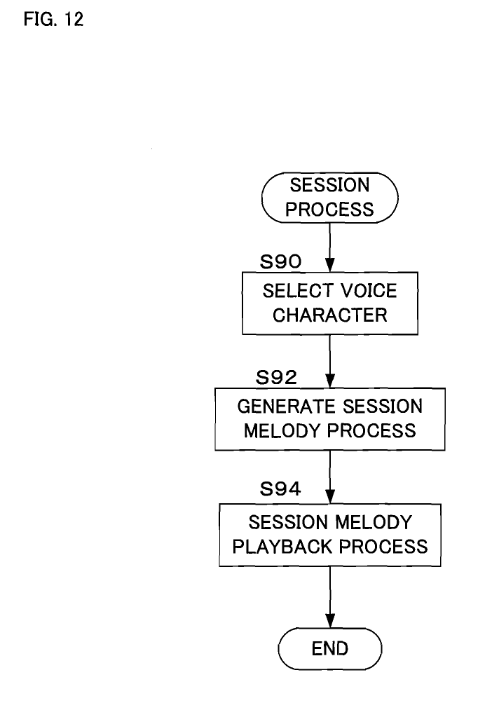

A session process for generating a session melody will be described with reference to the flowchart in FIG. 12. The session process is performed by the control part 15 of the game machine 1. First, a voice character with which the character 7 has a session is selected in step S90. For example, an identification number of a target voice character may be specified. Next in step S92, a session melody generating process is performed. In the session melody generating process, a session melody is generated by incorporating the melody for the voice character to each of the melody pieces included in the melody for the character 7 as described above. Accordingly, the control part 15 functions as a session melody generating device. Next, the process advances to step S94, and the session melody generated is play-backed. The play-backed session melody is outputted by the sound output device 11.

The present invention is not limited to the above-mentioned embodiment; and it can be embodied in various forms. For example, a character may be also provided at the initial stage which is common for all genres, and a unique melody piece to the character may be provided. Types of the evolution morphologies, the number of types of the genres, the number of source data, and the levels of the voice character are not limited to the numbers in the present embodiment. Furthermore, a storage device not shown in the drawings may store a character whose morphology is changed by a user. In this case, similar to the voice character, a unique identification number may be provided to each character; and the character may be identified suitably with the identification number.

Furthermore, a playback device may be built in the game machine 1, and the character may be displayed on the screen 2 or change its morphology on the basis of the music play-backed by the built-in playback device. In this case, when the media to be play-backed includes information indicating the genre of playback music, the information may be used, for example. The determination of evolution may be determined after the genres of all source data of the morphologic change status are set. The session melody may be a combination of the melody for the character 7 and the melody for the voice character. The number and the positions of the melody for the voice character and the melodies for the character 7 are not limited to those in the above-mentioned embodiment.

1. A game machine of playing a game in which a character evolves stepwise in a plurality of evolution processes with changing its morphology when a morphology changing factor is provided, the game machine comprising:
a character information storage device which stores character information, in which a character morphology indicating a current morphology of the character, a character melody which is a melody for the character morphology, and a morphologic change status of the character are correlated to each other;
an evolution morphology information storage device which stores evolution morphology information, in which a plurality of evolution morphologies associated with the plurality of evolution processes, morphology melodies each of which is a melody unique to each of the plurality of evolution morphologies, and the respective evolution requirements for evolving to the plurality of evolution morphologies are correlated to each other;
a morphology changing factor obtaining device which obtains a morphology changing factor;
a character changing device which changes the morphologic change status of the character stored in the character information storage device according to the morphology changing factor obtained; and
an evolution processing device which performs a process related to an evolution of the character when the morphologic change status of the character satisfies any of the evolution requirements in the evolution morphology information provided to the next evolution process of the current character, wherein
the evolution processing device comprises:
a morphology setting device which sets the evolution morphology correlated to the evolution requirement as the character morphology; and
an evolution melody setting device which generates an evolution melody on the basis of the character melody for the character and the morphology melody correlated to the set evolution morphology, and which sets the evolution melody generated as an advanced character melody.

2. The game machine according to claim 1, wherein the evolution melody is generated by concatenating the morphology melody to the character melody.

3. The game machine according to claim 1, wherein
the morphology changing factor is music data relating to playback music,
the character changing device comprises a genre determining device which determines a genre of the playback music from the music data obtained by the morphology changing factor obtaining device,
the morphologic change status is information relating to time periods, during which music in the respective genres are play-backed, and
the evolution requirement is a requirement based on the playback time periods of the music of the respective genres.

4. The game machine according to claim 3, comprising:
an information storage device for a voice character which stores information for voice character, which is provided according to a level relating to a pitch of a voice, and in which each of a plurality of voice characters having different morphologies from each other and the unique voice character melody to the voice character are correlated;
a voice input device which inputs voice data from outside;
a voice character selecting device which selects, from the information for voice character, a voice character according to the voice data inputted by the voice input device; and
a synthetic melody generating device which generates a synthetic melody by combining the voice character melody for the selected voice character and the character melody.

5. A game system of playing a game in which a character evolves stepwise in a plurality of evolution processes with changing its morphology when a morphology changing factor is provided, the game machine comprising:
a character information storage device which stores character information, in which a character morphology indicating a current morphology of the character, a character melody which is a melody for the character morphology, and a morphologic change status of the character are correlated to each other;
an evolution morphology information storage device which stores evolution morphology information, in which a plurality of evolution morphologies associated with the plurality of evolution processes, morphology melodies each of which is a melody unique to each of the plurality of evolution morphologies, and the respective evolution requirements for evolving to the plurality of evolution morphologies are correlated to each other;
a morphology changing factor obtaining device which obtains a morphology changing factor;
a character changing device which changes the morphologic change status of the character stored in the character information storage device according to the morphology changing factor obtained; and
an evolution processing device which performs a process related to an evolution of the character when the morphologic change status of the character satisfies any of the evolution requirements in the evolution morphology information provided to the next evolution process of the current character, wherein
the evolution processing device comprises:
a morphology setting device which sets the evolution morphology correlated to the evolution requirement as the character morphology; and
an evolution melody setting device which generates an evolution melody on the basis of the character melody for the character and the morphology melody correlated to the set evolution morphology, and which sets the evolution melody generated as an advanced character melody.

6. A computer-readable storage medium of storing a computer program which makes a computer of a game machine of playing a game to function, in the game a character evolves stepwise in a plurality of evolution processes with changing its morphology when a morphology changing factor is provided, and
the game machine comprises a character information storage device which stores character information, in which a character morphology indicating a current morphology of the character, a character melody which is a melody for the character morphology, and a morphologic change status of the character are correlated to each other; and an evolution morphology information storage device which stores evolution morphology information, in which a plurality of evolution morphologies associated with the plurality of evolution processes, morphology melodies each of which is a melody unique to each of the plurality of evolution morphologies, and the respective evolution requirements for evolving to the plurality of evolution morphologies are correlated to each other,
wherein the computer program makes the computer to function as: a morphology changing factor obtaining device which obtains a morphology changing factor; a character changing device which changes the morphologic change status of the character stored in the character information storage device according to the morphology changing factor obtained; and an evolution processing device which performs a process related to an evolution of the character when the morphologic change status of the character satisfies any of the evolution requirements in the evolution morphology information provided to the next evolution process of the current character, and
wherein the evolution processing device is configured to function as: a morphology setting device which sets the evolution morphology correlated to the evolution requirement as the character morphology; and an evolution melody setting device which generates an evolution melody on the basis of the character melody for the character and the morphology melody correlated to the set evolution morphology, and which sets the evolution melody generated as an advanced character melody.

7. The game machine according to claim 2, wherein
the morphology changing factor is music data relating to playback music,
the character changing device comprises a genre determining device which determines a genre of the playback music from the music data obtained by the morphology changing factor obtaining device,
the morphologic change status is information relating to time periods, during which music in the respective genres are play-backed, and
the evolution requirement is a requirement based on the playback time periods of the music of the respective genres.

8. The game machine according to claim 7, comprising:
an information storage device for a voice character which stores information for voice character, which is provided according to a level relating to a pitch of a voice, and in which each of a plurality of voice characters having different morphologies from each other and the unique voice character melody to the voice character are correlated;
a voice input device which inputs voice data from outside;
a voice character selecting device which selects, from the information for voice character, a voice character according to the voice data inputted by the voice input device; and
a synthetic melody generating device which generates a synthetic melody by combining the voice character melody for the selected voice character and the character melody.
